(19) United States
(12) Patent Application Publication
(10) Pub. No.: US 2016/0106060 A1
(43) Pub. Date: Apr. 21, 2016

(54) Pet Confinement Apparatus

(71) Applicant: Nancy Sundwall, North Haven, CT (US)

(72) Inventor: Nancy Sundwall, North Haven, CT (US)

(21) Appl. No.: 14/885,501

(22) Filed: Oct. 16, 2015

Related U.S. Application Data
(60) Provisional application No. 62/064,644, filed on Oct. 16, 2014.

(51) Int. Cl. A01K 1/02

(52) U.S. Cl. CPC A01K 1/0245

(57) ABSTRACT

A pet confinement apparatus provides a housing that confines and contains a pet. The pet confinement apparatus includes a housing having a base, one or more upstanding sidewalls, an open rear end, and an open upper end, that defines an interior volume. The housing further includes a front end, wherein one or more upstanding sidewalls are positioned at the front end and includes an aperture therethrough for receiving an animal's head. A door removably covers the open rear end, wherein the door controls access to the interior volume of the housing. In some embodiments, the pet confinement apparatus includes a plurality of wheels affixed to the base of the housing to provide convenient transportation. In other embodiment, the pet confinement apparatus includes one or more handles affixed to the housing for gripping, and a bowl affixed to the housing that is capable of storing food and water.

### CROSS REFERENCE TO RELATED APPLICATION

This application claims the benefit of U.S. Provisional Application No. 62/064,644 filed on Oct. 16, 2014. The above identified patent application is herein incorporated by reference in its entirety to provide continuity of disclosure.

### FIELD OF THE INVENTION

The present invention relates to a confinement apparatus. More specifically, the present invention relates to a pet confinement apparatus comprising a housing having a base, one or more upstanding sidewalls, an open rear end, and an open upper end, that defines an interior volume. The housing includes a front end, wherein one or more upstanding sidewalls are disposed at said front end and comprise an aperture therethrough for receiving an animal's head. A door removably covers the open rear end in order to control access to the interior volume of the housing.

### BACKGROUND OF THE INVENTION

Over recent years, there has been an upsurge in pet ownership worldwide. With an increase in ownership, pet health care services and providers have become more widespread. Pet health care providers offer services including prescribing medications and completing diagnostic tests on the animal to maintain and improve the animal's health. Many pets require a variety of medications for conditions such as arthritis, diabetes, and the like. Pet owners often administer these medication to their pets are their home, however, most pets are easily frightened and panicked. An animal flails about and moves unexpectedly when frightened and panicked, thereby risking injury to the pet and pet owner.

Typically, a pet owner may use his or her hands to hold their pet when administering medication in order to prevent the animal from leaving. However, due to the unpredictable movements of the pet, administering medication in this manner is dangerous to the pet and to the pet owner, especially if the medication requires the use of a needle. Other pet owners may use a cage or similar device to confine their pet prior to administering the medication. However, the cage may not be the appropriate size to properly restrict movement of the pet. Further, a cage is enclosed and does not allow the individual convenient, unobstructed access to the pet therein for administering medication.

Conventional methods of administering medications and health care services to a pet include confining the pet within a cage or using restraints to restrict the movement of the pet. Additionally, some veterinary hospitals use anesthesia or other sedatives to relax the pet prior to the providing the health care service. Each of these conventional ways of restraining a pet create a stressful environment for the pet, causing anxiety and agitation for the pet and pet owner. Accordingly, it is desirable to provide a pet confinement apparatus that confines a pet within a housing and creates a harmonious atmosphere. It would be further desirable to provide a pet confinement apparatus that is portable.

### SUMMARY OF THE INVENTION

In view of the foregoing disadvantages inherent in the known types of pet confinement apparatuses now present in the prior art, the present invention provides a new pet confinement apparatus wherein the same can be utilized for confining a pet in order to facilitate the administration of medical services and the like.

The present invention relates to a pet confinement apparatus comprising a housing having a base, one or more upstanding sidewalls, an open rear end, and an open upper end, that defines an interior volume. The housing includes a front end, wherein one or more upstanding sidewalls are disposed at said front end and comprise an aperture therethrough. The aperture is configured to receive an animal's head and neck therethrough. A door is secured to the housing and removably covers the open rear end, wherein the door controls access to the interior volume of the housing. In some embodiments, a plurality of wheels are affixed to the underside of the base and provides for convenient transportation. In another embodiment, a bowl is affixed to the front end of the housing for receiving food and water.

It is therefore an object of the present invention to provide a new and improved pet confinement apparatus that has all of the advantages of the prior art and none of the disadvantages.

It is another object of the present invention to provide a pet confinement apparatus comprising a housing having a base, one or more upstanding sidewalls, an open rear end, and an open upper end, that defines an interior volume.

Another object of the present invention is to provide a pet confinement apparatus comprising an aperture disposed on a sidewall positioned at a front end of the housing, wherein the aperture is adapted to receive an animal's head therethrough in order to prevent the animal from observing medication administered thereto so the animal can remain calm while receiving medical treatment.

Another object of the present invention is to provide a pet confinement apparatus having an aperture disposed at the front end of the housing, wherein the aperture may be padded and configured to receive a portion of an animal therethrough.

Another object of the present invention is to provide a pet confinement apparatus having a bowl affixed to the front end of the housing that allows a pet to eat and drink therefrom when positioned within the housing of the pet confinement apparatus.

Another object of the present invention is to provide a pet confinement apparatus having a door secured to the housing, wherein the door removably covers a rear open wall of the housing in order to control access to the interior volume thereof.

Yet another object of the present invention is to provide a pet confinement apparatus that may be readily transportable via a plurality of wheels affixed to the underside of the base of the housing.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the pet confinement apparatus.

FIG. 2 shows a rear perspective view of an embodiment the pet confinement apparatus.

FIG. 3 shows a front view of an embodiment the pet confinement apparatus having a dog positioned within the housing.

FIG. 4 shows a side cutaway view of the pet confinement apparatus with a dog entering the housing.

FIG. 5 shows a side cutaway view of the pet confinement apparatus in use.

### DETAILED DESCRIPTION OF THE INVENTION

Reference is made herein to the attached drawings. Like reference numerals are used throughout the drawings to depict like or similar elements of the pet confinement apparatus. For the purposes of presenting a brief and clear description of the present invention, the preferred embodiment will be discussed as used for confining a pet in order to facilitate the administration of medical services and the like. The figures are intended for representative purposes only and should not be considered to be limiting in any respect.

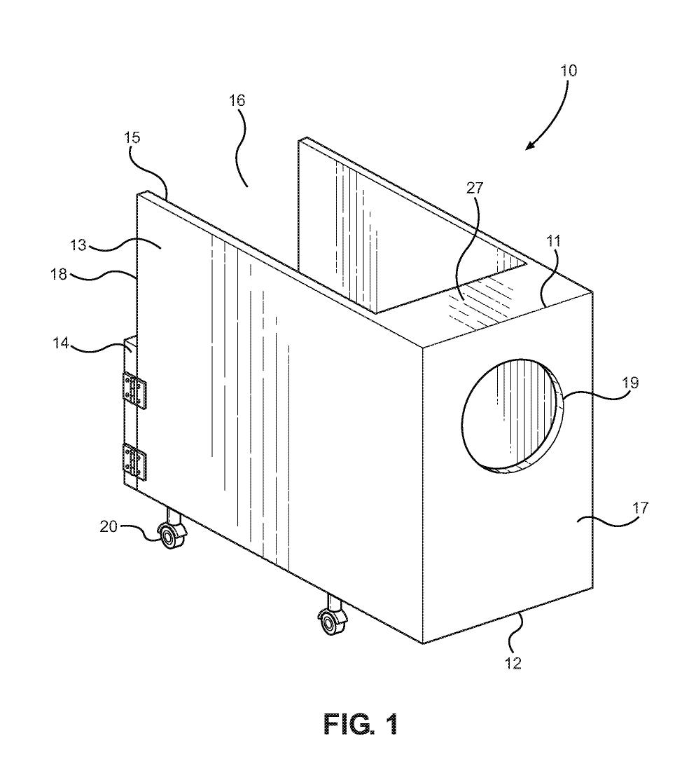

Referring now to FIG. 1, there is shown a front perspective view of an embodiment of the pet confinement apparatus. The pet confinement apparatus 10 comprises a housing 11 having a base 12, one or more upstanding sidewalls 13, an open rear end 18, and an open upper end 15, that defines an interior volume 16. The housing 11 includes a front end 17, wherein one or more upstanding sidewalls 13 are disposed at the front end 17 and comprise an aperture 19 configured to receive a pet body part therethrough. In the illustrated embodiment, the pet confinement apparatus 10 comprises a plurality of wheels 20 removable affixed to the underside of the base 12 of the housing 11 via any suitable fastener. In one embodiment, the wheels 20 are caster wheels. The wheels 20 allow for mobility and convenient transportation of the housing 11.

In the illustrated embodiment, the base 12 and the sidewalls 13 of the housing 11 are planar members that comprise a configuration rectangular in shape. The rectangular shape enables a narrow body of a pet to easily fit within the housing. The housing 11 is dimensioned to contain and confine pets having various sizes. In other embodiments, the pet confinement apparatus 10 can comprises any suitable cross section, such as polygonal, that allows for confinement of an animal therein.

The open upper end 15 of the housing 11 provides access to the interior volume 16 thereof through which health care services, such as the administration of medication, may be provided to a pet positioned within the housing 11. Additionally, the open upper end 15 provides ventilation to the interior volume 16 which provides air flow to the pet positioned therein, thereby allowing the pet to remain calm and relaxed. In the illustrated embodiment, the housing 11 further comprises a top member 27 affixed to an upper end of at least one of the sidewalls 13. The top member 27 partially covers the open upper end 15 in order to provide additional structural support to the housing 11 and assist with the confinement of a pet within the housing 11.

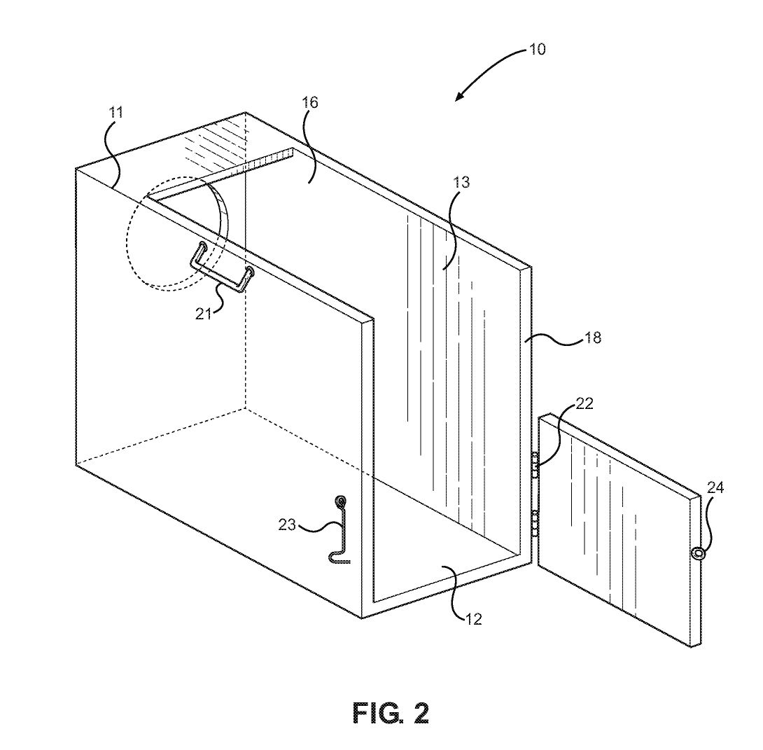

Referring now to FIG. 2, there is a rear perspective view of an embodiment the pet confinement apparatus. The pet confinement apparatus 10 further comprises a door 14 secured to the housing 11, wherein the door 14 removably covers the open rear end 18 of the housing 11 in order to control access to the interior volume 16 thereof. In the illustrated embodiment, the door 14 comprises a planar member hingedly affixed to one of the sidewalls 13 via one or more hinges and securable to one or more opposing sidewalls 13 via a fastener. The door 14 is movable between an open and closed configuration. In an open configuration, the door 14 is removed from covering the open rear end 18 of the housing 11 permits access to the interior volume 16 of the housing 11. In this way, a pet is permitted to enter the interior volume 16 of the housing 11 through the rear end 18 of the pet confinement apparatus 10 through the door 14 that is in an open configuration.

In a closed configuration, the door 14 covers the rear end 18 of the housing 11 and is substantially flush with the edges of the sidewalls 13. The door 14 restricts entrance to or exit from the interior volume 16 thereof. In the illustrated embodiment, the door 14 can be closed on one or more hinges 23 and secured in a closed configuration by a fastener, such as a latch 23, to prevent the pet from exiting the housing 11. In the illustrated embodiment, the fastener comprises a latch 23 disposed on the rear end 18 of one of the sidewalls 13 and an eyelet 24 disposed on the door, wherein the latch 23 is configured to removably secure to the eyelet 24. In alternative embodiments, the fastener may include any suitable fastener, such as a snap fastener, a clasping mechanism, among others.

In the illustrated embodiment, the pet confinement apparatus 10 comprises a rectangular cross section, however, in alternative embodiments the pet confinement apparatus 10 can comprises any suitable cross section, such as polygonal. In some embodiments, one or more sidewalls 13 of the pet confinement apparatus 10 comprise one or more handles 21 disposed thereon. The handle 21 is configured to be hand gripped, thus allowing a user to lift or otherwise manipulate the pet confinement apparatus 10.

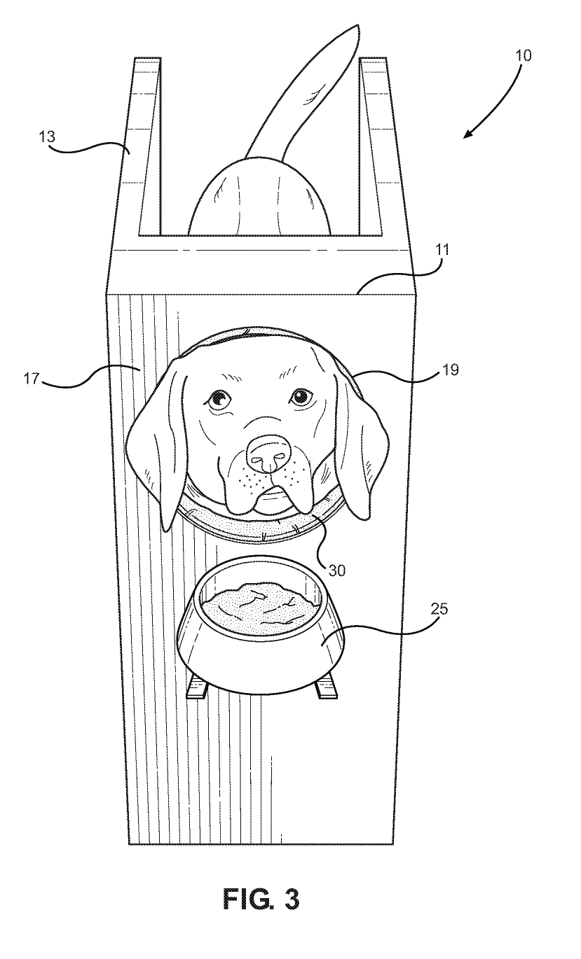

Referring now to FIG. 3, there is a front view of an embodiment the pet confinement apparatus having a dog positioned within the housing. In the illustrated embodiment, a pet is positioned within the housing 11 of the pet confinement apparatus 10 having the head and neck of the pet disposed through the aperture 19 configured to receive a pet body part. The aperture 19 disposed on the front end of the housing is configured to receive the head of an animal therethrough, such as a dog, cat, goat, and the like. In the shown embodiment, the aperture 19 has a circular cross section, however, in alternative embodiments, the aperture 19 cross section may include any suitable shape such as a polygon or rectangle. Additionally, when a pet's head is positioned through the aperture 19, the surrounding sidewalls 13 limit the field of vision of the pet. Many pets become nervous and startled when people or moving objects are behind them. Thus, the pet's limited field of vision when positioned in the housing 11 calms the pet because it is unaware of any movement therebehind. This, in turn, increases the effectiveness and efficiency of providing care to the pet by reducing the movement of the animal, allowing the pet owner to efficiently administer medication to a specific location on the animal.

In the illustrated embodiment, padding 30 is disposed around the periphery of the aperture 19 to provide cushioning and protect the pet while confined in the pet confinement apparatus 10. When the head and neck of a pet are positioned through the aperture 19, the padding 30 provides protection to the pet's head and neck from accidental contact in approximately all directions, and provides for a surface that a pet may rest their head or neck thereon. In alternative embodiments, the padding 30 partially cover the periphery of the aperture 19.

In the illustrated embodiment, one or more upstanding sidewalls 13 disposed at the front end 17 comprise a 25 bowl affixed thereon. The bowl 25 comprises a base, one or more sidewalls, and an open upper end, defining an interior volume, wherein the bowl is configured to receive food and water therein. Further, the bowl 25 is positioned, such that, a pet having their head disposed through the aperture 19 may access the contents supported by the bowl 25. In some embodiments, the bowl 25 is removably affixed to one or more sidewalls 13 via a fastener, such as an adhesive, Velcro, and the like. In alternative embodiments, the bowl 25 is supported via one or more brackets that extend from the front end 17 of the housing 11.

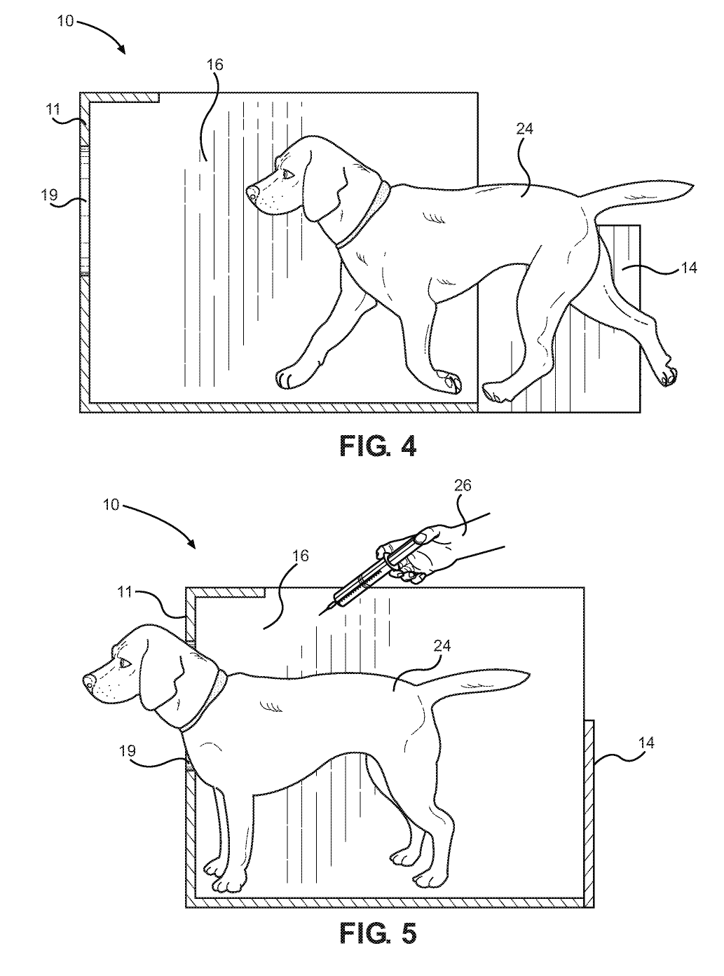

Referring now to FIGS. 4 and 5, there are shown side cutaway views of the pet confinement apparatus with a dog entering the housing and a dog within the housing receiving medical treatment. The pet confinement apparatus 10 provides a housing that is adapted to confine and contain a pet, thereby restricting the ability of the pet to move within the housing. In operation, a pet 24 enters the interior volume 16 of the housing 11 through the open rear end 18 of thereof, wherein the door 14 is disposed in an open configuration. Once the pet 24 is substantially inside the housing 11, the door 14 is closed and the head of the pet 24 is inserted through the aperture 19. A pet owner, veterinarian, or other individual 26 may then provide pet health care and related services, including the administration of medications and diagnostic examination on the pet 24 to maintain and improve the pet's health.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An pet confinement apparatus, comprising:
a housing comprising a base, one or more upstanding sidewalls, an open rear end, and an open upper end, defining an interior volume;
wherein said housing comprises a front end opposing said open rear end;
wherein said one or more upstanding sidewalls are disposed at said front end of said housing and comprise an aperture configured to receive a portion of an animal therethrough;
a door removably covering said open rear end.

2) The pet confinement apparatus of claim 1, wherein said door is hingedly affixed to a sidewall of said one or more upstanding sidewalls.

3) The pet confinement apparatus of claim 1, wherein said door is securely closable by a fastener.

4) The pet confinement apparatus of claim 1, wherein said housing further comprises a plurality of wheels affixed thereunder.

5) The pet confinement apparatus of claim 1, wherein said housing further comprises a bowl affixed to said front end, wherein said bowl is configured to house food and water therein.

6) The pet confinement apparatus of claim 1, wherein said aperture further comprises padding disposed around the periphery thereof.

7) The pet confinement apparatus of claim 1, wherein said housing further comprises one or more handles affixed to said one or more upstanding sidewalls.

8) The pet confinement apparatus of claim 1, wherein said housing further comprises a top member affixed to at least one of said one or more upstanding sidewalls and wherein said top member partially covers said open upper end of said housing.
